(19) United States
(12) Patent Application Publication
(10) Pub. No.: US 2005/0062988 A1
(43) Pub. Date: Mar. 24, 2005

(54) Using a removable grid for alignment and trim adjustments for printing jobs

(76) Inventors: Karl R. Schultz, Hilton, NY (US); Karl Heinz Kremer, Rochester, NY (US)

Correspondence Address: Mark G. Bocchetti;Eastman Kodak Company, 343 State Street, Rochester, NY, 14650-2201, US

(21) Appl. No.: 10/760,917

(22) Filed: Jan. 20, 2004

Related U.S. Application Data
(60) Provisional application No. 60/447,453, filed on Feb. 14, 2003.

(51) Int. Cl. H04N 1/40; H04N 1/23

(52) U.S. Cl. 358/1.9; 358/406

(57) ABSTRACT

In a printing environment a desired document is proofed by superimposing an alignment grid on the desired document and printing the grid and desired document on a receiver to check alignment of on the printed desired document to the receiver and once alignment is acceptable, removing the grid. The desired document or print job may then be printed without the grid.

### RELATED APPLICATIONS

This application claims the benefit of the filing date Provisional Application Ser. No. 60/447,453 entitled “USING A REMOVABLE GRID FOR ALIGNMENT AND TRIM ADJUSTMENTS FOR PRINTING JOBS” filed on Feb. 14, 2003.

### FIELD OF THE INVENTION

This invention is in the field of printing, and is more specifically directed to using a removable grid to facilitate image alignment and trim adjustments.

### BACKGROUND

Electrographic printing has become the prevalent technology for modem computer-driven printing of text and images, on a wide variety of hard copy media. This technology is also referred to as electrographic marking, electrostatographic printing or marking, and electrophotographic printing or marking. Conventional electrographic printers are well suited for high resolution and high speed printing, with resolutions of 600 dpi (dots per inch) and higher now available even at modest prices. At these resolutions, modem electrographic printers and copiers are well-suited to be digitally controlled and driven, and are thus highly compatible with computer graphics and imaging.

A typical electrographic printer includes a primary image forming photoconductor, which is a moving belt in large scale printers, or a rotating drum in smaller laser printers and photocopiers. The photoconductor is initially sensitized or conditioned by the application of a uniform electrostatic charge at a primary charging station in the printer. An exposure station forms an image on the sensitized photoconductor by selectively exposing it with light according to the image or text to be printed. The exposure station may be implemented as a laser, an array of light emitting diodes (LEDs), or a spatial light modulator. In modern electrographic printing, a computer typically drives the exposure station in a raster scan manner according to a bit map of the image to be printed. The exposing light discharges selected pixel locations of the photoconductor, so that the pattern of localized voltages across the photoconductor corresponds to the image to be printed.

Electrographic printing is computer driven, in that a computer workstation or other computer device generates digital data that define the desired image to be printed by the electrographic printer. These data represent the location and intensity of each pixel that is exposed by the printer. Conventionally, digital images (including styled text) are converted by a Raster Image Processor (RIP) from their form in a page description language to a sequence of serial instructions for the electrographic printer. For example, the contents of a word processing document with styled text is translated by the RIP into serial printer instructions that include, for the example of a binary black printer, a bit for each pixel location indicating whether that pixel is to be black (exposed and printed) or white (not exposed). The RIP can be dedicated hardware, or a software routine such as a printer driver, or some combination of both, for accomplishing this task.

More specifically, conventional raster image processing begins with a page description generated by the computer application used to produce the desired image. In a process sometimes known as “ripping”, the RIP interprets this page description into a display list of objects which contains a descriptor for each text and non-text object to be printed; for example in the case of text, the descriptor specifies each text character, its font, and its location on the page. The RIP then renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Ripping refers generally to one or more of the functions of the RIP.

The field of digital computer hardware and computer software has provided a large and still-increasing number of computer users with highly sophisticated document creation tools. Many business and individuals now have the ability to create pleasing and creative high-quality documents from their personal computer workstations. These documents include conventional business documents, books, brochures, signage, and the like, which range in complexity from simple text documents to complex documents that include full-color images and multiple paper sizes and types. The term “desktop publishing” is used to describe the capability of a common computer user to publish works that previously required expensive equipment and highly trained personnel. These improved computer tools have also increased the productivity of trained graphic artists in creating and publishing printed works.

The complexity and appearance of the printed documents has placed additional pressure on the processes and equipment for producing printed output. Widespread deployment of software tools has enticed many authors to create more complex documents than otherwise would have been created. For example, color output is now a staple of many printed documents, and is often expected of certain documents, such as sales and professional brochures. These tools provide ease with which document content can be edited and rearranged, for example to personalize the document specific recipients or to frequently update document content. Efforts regarding such tools have led to continuing developments to improve their versatility, practicality and efficiency.

### BRIEF DESCRIPTION OF THE DRAWINGS

FIG. 1 is a schematic block diagram of an image-forming machine or printing system having a graphic user interface with interconnection architecture where a software application implements a functionality and provides a plug-in interface with another software application.

FIG. 2 is an illustration of a typical image that is displayed on a user interface and printed on a receiver by a print system.

FIG. 3 is an illustration of a grid superimposed over a typical image that is displayed on a user interface and printed on a receiver by a print system in accordance with the present invention.

FIG. 4 is an illustration of multiple grids superimposed over a typical image that is displayed on a user interface and printed on a receiver by a print system in accordance with the present invention.

FIG. 5 is an illustration of a data entry table for setting the parameters of a grid that is displayed on a user interface and printed on a receiver by a print system in accordance with the present invention.

### DETAILED DESCRIPTION OF THE INVENTION

The present invention will be described in connection with a printing environment having one or more printing machines operated by a network of servers and workstations. It is contemplated, however, that this invention may be applied to a wide range of printing applications and systems, in which the benefits of this invention will accrue. Accordingly, it is to be understood that this description of the present invention is presented by way of example only, and that this description is not to limit the true scope of the invention as claimed.

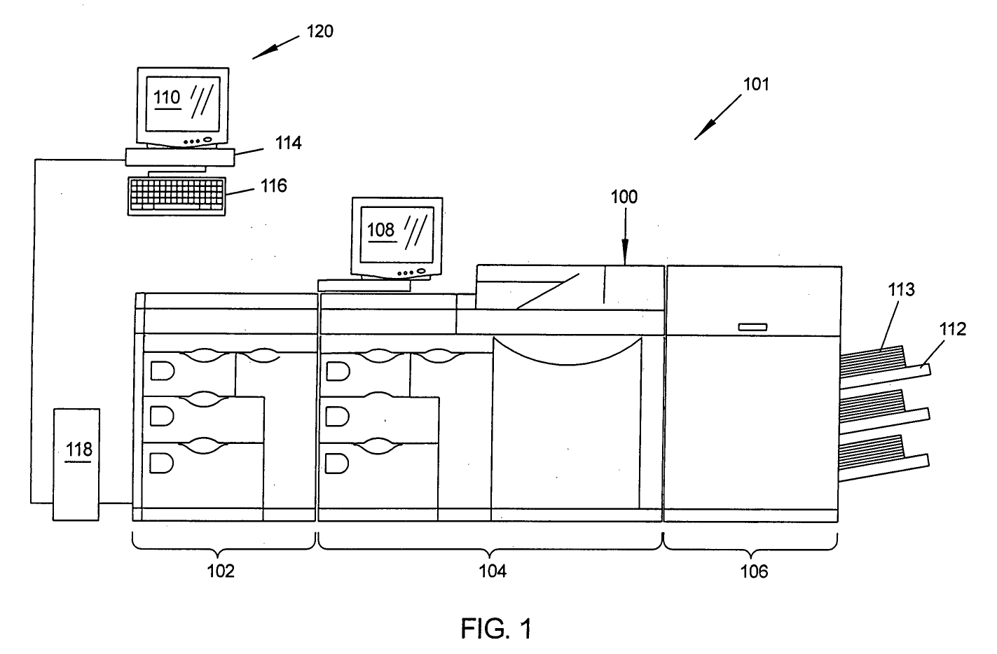

FIG. 1 illustrates a portion of a typical print shop environment into which the present invention is implemented. The overall print shop environment in which the portion of FIG. 1 resides can be quite varied, depending upon the facility and its function (e.g., commercial service bureau, or corporate print shop). An example of a full service commercial high volume print shop configuration into which the portion illustrated in FIG. 1 can be implemented is described in U.S. Pat. No. 6,407,820 B1, commonly assigned herewith and incorporated herein by this reference. This U.S. Pat. No. 6,407,820 B1 also describes an exemplary workflow into which the present invention can be readily implemented, to which the following description will refer by way of example.

Referring to FIG. 1, printing system 101 has an image-forming machine 100 having one or more remote workstations 120 having graphic user interfaces (GUI) 110. The workstation GUI is provided digital graphic signals from a computer or the like having an input device such as a keyboard, mouse or the like for entering commands. Loaded on the computer 114 are software applications. One such application implements a document or image-viewing functionality and provides a plug-in interface to another software application implementing an image-forming management functionality in the image-forming machine 100. Many functionalities, such as proofing, editing, drafting, and comparing may be provided by the such software applications. Other or additional software applications may be used to implement a functionality. While particular configurations and arrangements are shown, other configurations and arrangements may be used including those with other and additional components.

The image-forming machine 100 may be an electrophotographic device such as one of the Digimaster® digital printers manufactured by Heidelberg Digital L.L.C. located in Rochester, N.Y. The image-forming machine 100 also may be another electrophotographic machine, a photocopy machine, a printing device, or the like. The image-forming machine 100 has a computer 118, a feeder 102, a marking engine 104, a finisher 106, and a printer use interface 108 which may be separate or integrated components. The printer user interface 108 may be a display unit with push buttons, mouse or keyboard (not shown) or other activation means for inputting control parameters to the image-forming machine 100.

The feeder 102 provides receivers, or printing or copying sheets to the printing engine 104. The sheets may be one or a combination of paper, transparencies, and other medium. The sheets may be configured with pre-punched holes, tabs, and the like. The marking engine may include a photoconductor (not shown), one or more chargers (not shown), an exposure machine (not shown), a toning station (not shown), and a fuser station (not shown). In operation, the photoconductor is selectively charged and optically exposed to form an electrostatic latent image on the surface. Toner is deposited onto the photoconductor surface. The toner is charged, thus adhering to the photoconductor surface in areas corresponding to the electrostatic latent image. The toner image is transferred onto the sheet. In the fuser station, the sheet is heated causing the toner to fix or adhere to the paper or other medium. The sheet exits the marking engine 104 and enters the finisher 106, which may discharge the sheets as is or may perform one or more finishing operations such as stapling, folding, and inserting an inserted sheet and be deposited one or more stacking trays 112. The location of one or more tray 112 may be in other places than that shown. The sheets 113 will most likely have provided thereon an image which is or was at one time displayed on remote GUI 110 and/or the local marking engine GUI 108.

The GUI 110 may be a separate component such as a dedicated desktop or other personal computer operatively connected to a printer computer 118 of the image-forming machine 100. The GUI 110 also may be integrated with the printer user interface 108 or other components of the image-forming machine 100. The printer computer 118 is operatively connected to a logic control unit (not shown) in the image-forming machine 100. Operatively connected includes transmission or communication means such as electrical, radio, network, and the like. The GUI and the logic control unit also may be integrated into the same component. The logic control unit is connected to control the feeder 102, the marking engine 104, the finisher 106, and the printer user interface 108. The GUI 110 comprises a display screen (not shown) and an interfacing means such as a touch screen (not shown), a keyboard (not shown), a mouse (not shown), a track ball (not shown), or a combination thereof. The GUI 110 also may include tear-off menus, floating buttons, dialog boxes, alternate keyboard command and mouse shortcuts, and other alternative physical input devices.

The GUI 110 provides visual interaction with the image-forming machine 100 using one or more applications that implement one or more functionalities such as a document or image viewing/editing/creation functionality and an image-forming management functionality which may be implemented via a plug-in architecture. A plug-in architecture allows enhancements and updates to be incorporated in a simpler and more efficient manner and without requiring recompilation of the program codes that implement the functionalities. Using a plug-in architecture only requires you to recompile the plug-in that provides the desired functionality and not the core application. However, other architectures may be used as is known in the art.

Document or image viewing functionality provides a centralized viewing window for viewing electronic images of the original documents in a print job. For example, Adobe Acrobat® software application, manufactured by Adobe® Systems, Inc. located in San Jose, Calif., may implement the document or image viewing functionality on the image-forming machine 100. Other document or image viewing software applications may be used.

Image-forming management functionality integrates various software applications that implement, control, or manage the image-forming machine 100. The image management functionality visually represents objects (documents, tickets, other entities, operations, and the like) with icons, tree structures, and pull-down menus. A user may interact with the image management functionality using various interaction means such as the touch screen, the mouse, the track ball, and the keyboard. Such interaction with the visual representations results in manipulation of the underlying objects. While the image-forming management functionality may have an object-oriented appearance, the implementation of the functionality may be by an object oriented programming language or a non-object oriented programming language. In one aspect, the image-forming management functionality is implemented by an ImageSmart® Document Mastering SmartBoard™ software application used with Digimaster® digital printers manufactured by Heidelberg Digital L.L.C. located in Rochester, N.Y. Other image-forming management software applications may be used.

Various computer stations may be networked with multiple printing output devices (printers) 100. These computer stations include one or more job preparation stations, one or more network servers, and at least one print server. Additional workstations, for example so-called “storefront” workstations for use by print customers in the context of a commercial print shop or service bureau, may be optionally included in the environment. These systems may be interconnected over a conventional Ethernet network. Of course, other network arrangements and technologies, including both local area network and wide area networks of various configurations, and combinations thereof, can alternatively be used as the network backbone.

Sometimes when printing a document, it is important that the front and back sides are perfectly aligned (e.g. book publishing), it is very hard to adjust the alignment without any other tools. In some cases it may be possible to use existing page content (e.g. page numbers or headers or footers), but most documents do not have page content that is always at the same location.

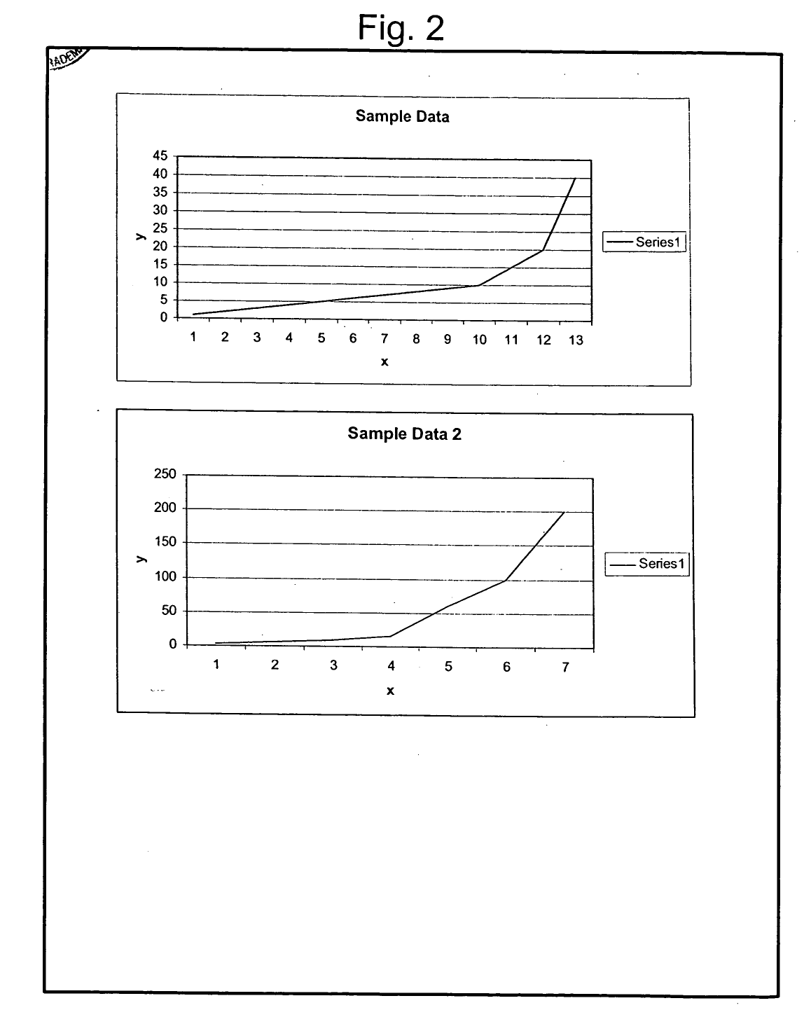

Referring to FIG. 2, a typical printed sheet 113 will contain an image having text and/or graphical information that represent the desired document after printing which was displayed on a GUI before printing using a viewing functionality software application.

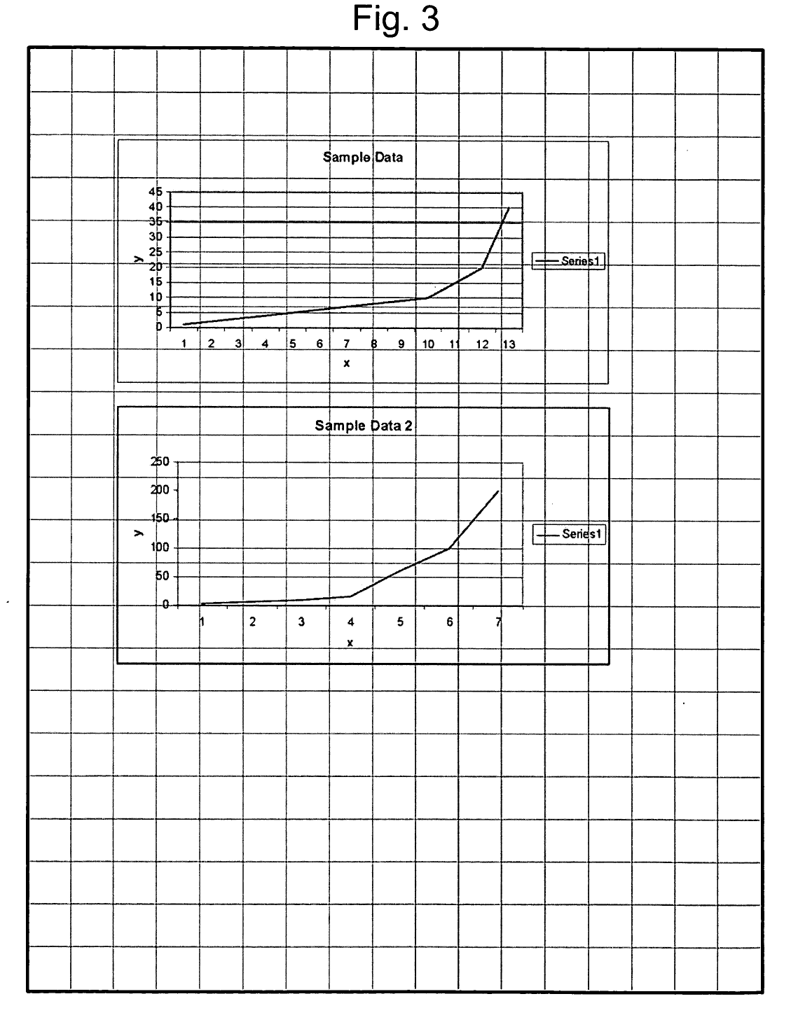

Referring to FIG. 3, a grid may be added to, superimposed on or overlayed on the desired document image by the heretofore mentioned software application in order to facilitate proper alignment of the desired image to the printed sheet, and/or alignment of the text and graphical information within the image. In order to verify or check proper alignment of the image on the printed sheet, the software application provides for the grid to be printed on the printed sheet along with the desired image. Once a proofer or editor is satisfied the image is aligned properly on the printed sheet, the software application may remove the grid and the sheet may be printed so that only the desired image is on the printed sheet.

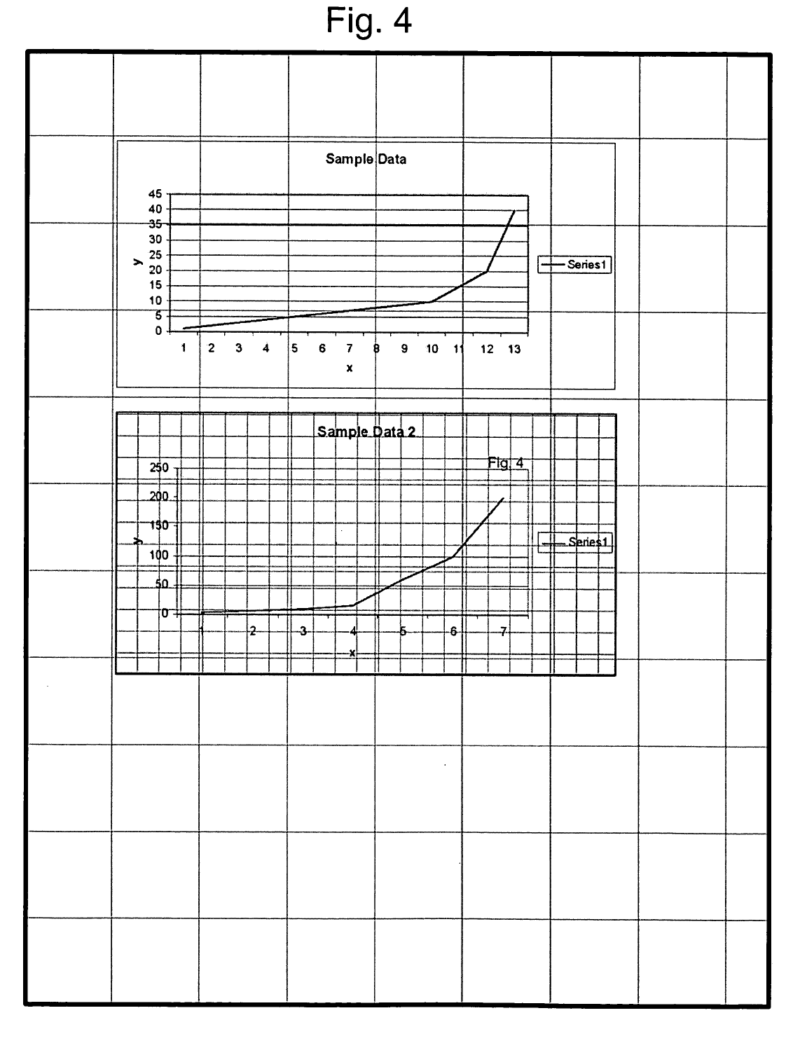

Referring to FIG. 4, multiple grids may be added to, superimposed on or overlayed on the desired document image by the heretofore mentioned image viewing software application in order to facilitate proper alignment of the desired image to the printed sheet, and/or alignment of the text and graphical information within the image. In order to verify or check proper alignment of the image on the printed sheet, the software application provides for the grid to be printed on the printed sheet along with the desired image. Once a proofer or editor is satisfied the image elements are aligned properly on the printed sheet, the software application may remove the grid and the sheet may be printed so that only the desired image is on the printed sheet.

The software application may be implemented as an Adobe Acrobat® plug-in. The plug-in interface allows to provide additional functionality to a user of Adobe Acrobat® and preferably is indistinguishable from core Acrobat® functionality.

The alignment grid is particularly useful when the user works with a document that requires accurate front/back alignment, or requires adjustments of trim positions.

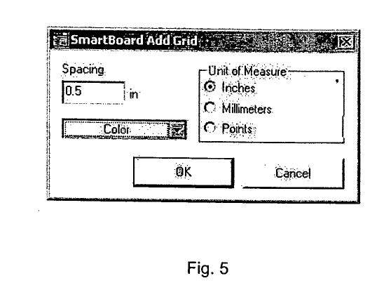

Referring now to FIG. 5, the user may access the grid functionality via two menu items on Adobe Acrobat's menu bar: “Add Grid” and “Remove Grid”. When the “Add Grid” menu item is selected, a dialog window may be displayed that allows the user to specify the grid properties. The “Spacing” input field allows to specify the distance between the grid lines. One or more input fields for horizontal and vertical line spacing may be specified. The “Unit of Measure” selection provides the unit in which the line spacing was specified. It may default to the unit selection of Adobe Acrobat®. The “Color” user interface element may display a color picker to specify the grid color. When adding the grid lines, Acrobat® may store additional information with the new page content, so that it can be identified as one group of elements at a later time. When the “OK” button is selected, the specified grid may be added to one or more page in the document. When a grid is added to a page that already contains a grid, the original grid may be removed before the new grid is added or both grids may remain. The grid may be aligned to different locations on the page, such as either the lower left corner, the center of the page, the lower right corner, the upper left corner or the upper right corner. The grid may also be rotated so that it can be used to measure the skew angle of scanned images. It may also provide the capability to select different alignment configurations for odd and even pages.

After the grid is added to the document, the user can print the document the same way it would be printed without the grid. By adding the grid to the page content, one can make sure that the document is processed the same way as without the grid. The printer's internal test pattern generator may inject the test pattern page images close to the point where the images get transferred to the physical page (usually in the buffer that holds the images that are ready for printing). The software application forces the grid pattern to be processed by all stages of the ripping process. For example, any image shift that is applied in the PDF interpreter, or the PostScript interpreter will also be applied to the printed document. This shift would not be applied to test images created in the printer. If the printed output shows a misalignment (such as between the front and back sides of the printed pages), the user can adjust the alignment of one or both sides by shifting one or both images by the amount indicated by the test print. Once alignment is acceptable, the grid can be removed from the document again by selecting the “Remove Grid” menu item. This function will go through the document pages and check for the group of elements that makes up the grid on the page. If this group of elements is identified, it will be removed from the page content. By doing this, the original page content will be restored again.

The grid may be used for the following applications: Establish and verify front/back alignment; Fine trim adjustment for the booklet maker (useful for oversized covers that are sent to the booklet maker); Alignment for inline perfect binder and three knife trimmer; Verify alignment of MICR characters to MICR standard; Verify alignment of bar code placement; Verify shift operation; Align text that is placed with the text tool; Create graph paper; Demonstrate machine quality and consistency; and, Align machine for custom paper sizes.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A method of proofing a desired document stored in digital format, comprising the steps of:
displaying a compound document on a user interface, the compound document comprising an alignment grid overlaying the desired document; and,
printing at least a portion of the displayed compound document on a receiver to observe alignment of the document to the alignment grid on the printed receiver.

2. A method according to claim 1, further comprising the step of editing the desired document if alignment errors are detected on the printed compound document.

3. A method according to claim 1, wherein the alignment grid is printed on both sides of the receiver.

4. A method according to claim 1, further comprising the step of removing the alignment grid and printing the desired document.

5. A method of proofing a document from a digital file, comprising the steps of:
displaying a compound document on a user interface, the compound document comprising the document and an alignment grid; and,
printing at least a portion of the displayed compound document on a receiver to observe alignment of the document to the alignment grid.

6. A method according to claim 5, further comprising the step of editing the desired document if alignment errors are detected on the printed compound document.

7. A method according to claim 5, wherein the alignment grid is printed on both sides of the receiver.

8. A method according to claim 5, further comprising the step of removing the alignment grid and printing the desired document.

9. A method of proofing a desired document stored in digital format, comprising the step of printing on a receiver an alignment grid superimposed on at least a portion of the desired document to observe alignment of the grid and desired document on the printed receiver.

10. A method in accordance with claim 9, further comprising the step of editing the desired document if alignment errors are detected on the printed compound document.

11. A method according to claim 9, wherein the alignment grid is printed on both sides of the receiver.

12. A method according to claim 9, further comprising the step of removing the alignment grid and printing the desired document.

13. A method of proofing a desired document stored in digital format, comprising the steps of:
displaying a compound document on a user interface, the compound document comprising an alignment grid overlaying the desired document; and,
printing at least a portion of the displayed compound document on a receiver to facilitate alignment of the printed desired document to the printed alignment grid.

14. A method of proofing a desired document stored in digital format, comprising the steps of:
displaying a compound document on a user interface, the compound document comprising an alignment grid overlaying the desired document; and,
printing at least a portion of the displayed compound document on a receiver to enable comparison of the alignment of the displayed compound document to the alignment of the printed compound document.

15. A method of proofing a desired document stored in digital format, comprising the steps of:
printing an alignment grid overlaying at least a portion of the desired document;
electronically removing the alignment grid; and,
printing the desired document without the alignment grid.

16. A method of proofing a desired document stored in digital format, comprising the steps of:
displaying a compound document on a user interface, the compound document comprising an alignment grid overlaying the desired document; and,
printing at least a portion of the displayed compound document on a receiver to observe alignment of the document to the alignment grid on the printed receiver;
removing the alignment grid; and,
printing the desired document without the alignment grid.
